(19) United States
(12) Patent Application Publication
(10) Pub. No.: US 2005/0280258 A1
(43) Pub. Date: Dec. 22, 2005

(54) Sports tracking device

(76) Inventor: Thomas M. Wien, Newport Beach, CA (US)

Correspondence Address: Eric K. Satermo;Registered Patent Agent, P.O. Box 19099, Irvine, CA, 92623-9099, US

(21) Appl. No.: 11/052,007

(22) Filed: Feb. 4, 2005

Related U.S. Application Data
(60) Provisional application No. 60/541,641, filed on Feb. 4, 2004.

(51) Int. Cl. B42D 15/00

(52) U.S. Cl. 283/117

(57) ABSTRACT

A sports tracking device simultaneously displays a current standing of each team in a sports league, such as Major League Baseball® or the National Football League®. The sports tracking device may include a board with a printed surface. The printed surface may include one or more sets of regular-season fields and one or more sets of playoff fields. Each set of regular-season fields may include a plurality of primary division fields each corresponding to a primary division of the sports league, and each set of playoff fields may include a plurality of series fields, with the playoff fields being divided into a plurality of playoff rounds. A plurality of team icons are respectively associated with the teams of the sports league, with each of the team icons being releasably receivable and positionable on the printed surface of the board, for example, by magnets. Accordingly, the icons can be positioned in one of the primary division fields to indicate a current regular-season standing of the teams or in one of the series fields to indicate a current playoff standing of the teams.

### CROSS REFERENCE TO RELATED APPLICATION

The present application claims priority on U.S. Provisional Application for Patent Ser. No. 60/541,641 filed Feb. 4, 2004, the entire disclosure of which is incorporated herein by reference.

### BACKGROUND OF THE INVENTION

The invention relates to methods and apparatus for visually presenting information in substantially real time. The invention also relates to methods and apparatus for displaying information related to sports leagues, such as Major League Baseball®, the National Football League®, the National Hockey League®, the National Basketball Association®, Major League Soccer®, European and Latin American soccer leagues, the various divisions and conferences of collegiate and interscholastic sports, and so on.

Many sports fans keep track of teams by accessing standings, for example, in the newspaper or on the Internet. The current standings provide a snapshot of where each team of a league is (e.g., standing, games back, etc.) on any given day. The standings provided in the print media are limited in their graphical representation of the current status of each team in a particular league.

To overcome the deficiencies in the print media, people often attempt to track sports information utilizing a conventional board. When a particular piece of information changes, a user erases the information and writes the updated information in its place. Other conventional boards include electronic boards and video displays, with information being changed on these types of boards by user input at an interface. In either of these cases, there is no board capable of tracking information related to the standings and the playoffs of every team in a sport league throughout the course of a season.

In view of the foregoing, there is a need in the art for a sports tracking board that intuitively, graphically, and clearly displays information on sports leagues.

### SUMMARY OF THE INVENTION

According to one aspect of the invention, a sports tracking device simultaneously displays a current standing of each team in a sports league, such as Major League Baseball® or the National Football League®. The sports tracking device may include a board with a printed surface. The printed surface may include one or more sets of regular-season fields and one or more sets of playoff fields. Each set of regular-season fields may include a plurality of primary division fields each corresponding to a primary division of the sports league, and each set of playoff fields may include a plurality of series fields, with the playoff fields being divided into a plurality of playoff rounds. A plurality of team icons are respectively associated with the teams of the sports league, with each of the team icons being releasably receivable and positionable on the printed surface of the board, for example, by magnets. Accordingly, the icons can be positioned in one of the division fields to indicate a current regular-season standing of the teams or in one of the series fields to indicate a current playoff standing of the teams.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 illustrates a sport tracking device for tracking the regular-season standings and the playoffs, of a sports league;

FIG. 2 is a perspective view of a sports tracking device;

FIG. 3 is a cross-sectional view of a magnetic board and a team icon;

FIG. 4 illustrates schematically a number of fields of a sports tracking device;

FIGS. 5A and 5B illustrate playoff fields according to a number of embodiments;

FIG. 6 illustrates a board for tracking Major League Baseball;

FIG. 7 illustrates a kit for displaying a sports tracking device;

FIG. 8 is a cross-sectional view of a card holder of the kit of FIG. 7; and

FIG. 9 illustrates a computer-based sports tracking device.

### DETAILED DESCRIPTION OF THE INVENTION

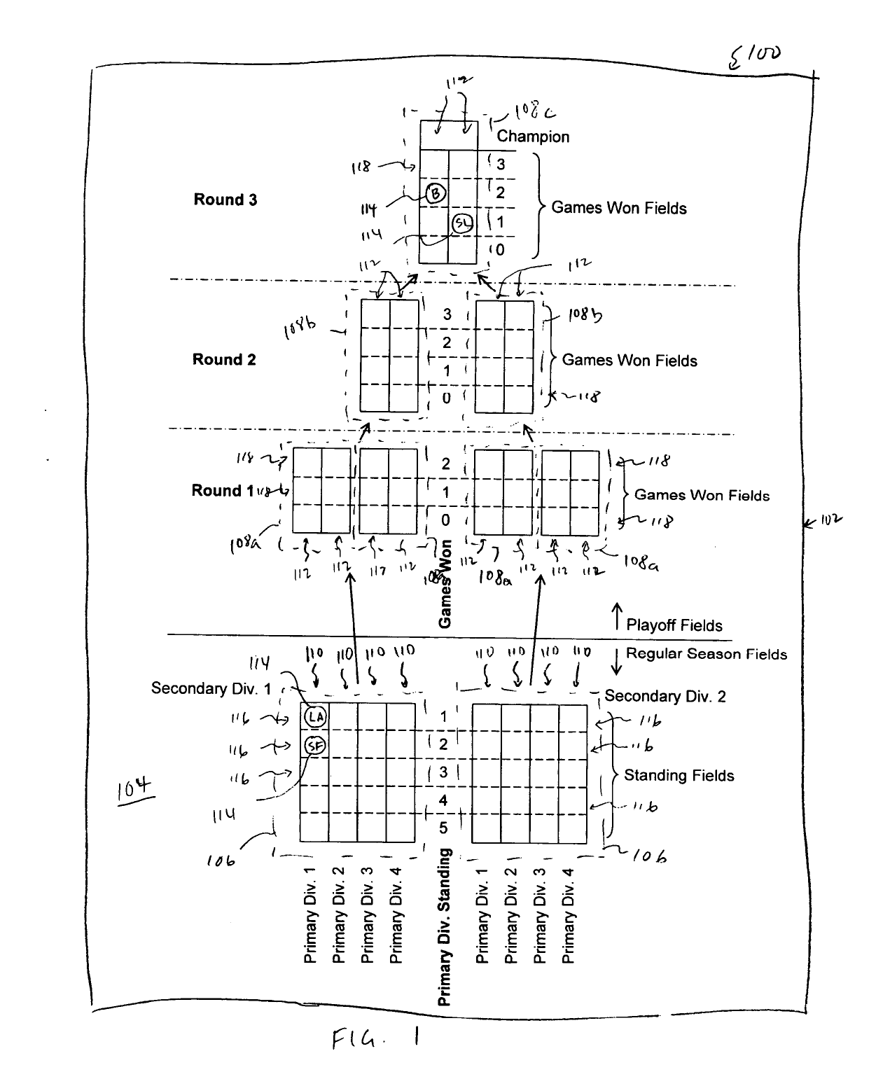

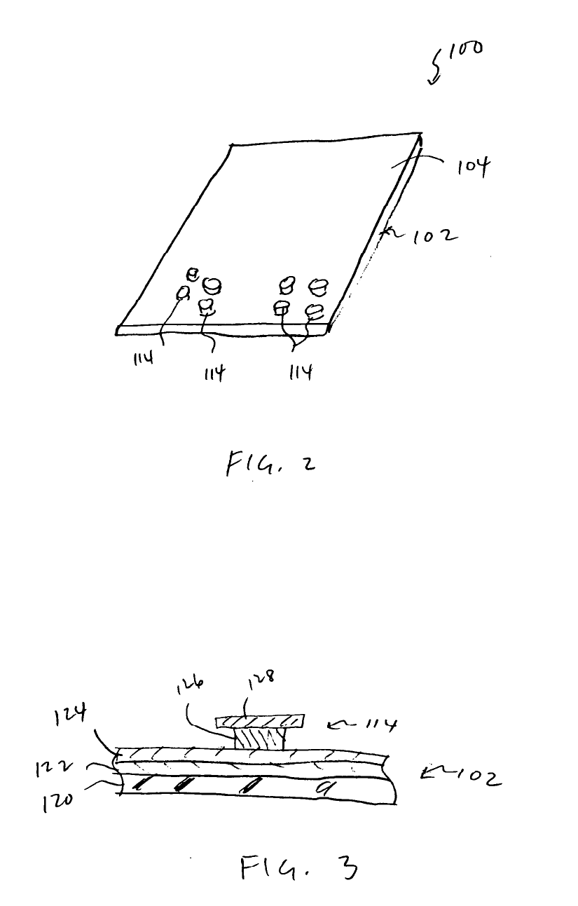

Referring to FIGS. 1 and 2 of the drawings, a sports tracking device 100 for simultaneously displaying a current standing of each team in a sports league is illustrated. For example, the sports tracking device 100 may be configured to provide current information on one of the professional sports leagues in the United States, such as Major League Baseball®, the National Football League®, the National Hockey League®, the National Basketball Association®, Major League Soccer®, or the Nextel Cup Series® for NASCAR®, examples of which are discussed in detail below. For the purposes of the description, terminology associated with Major League Baseball® will be utilized in describing the invention.

According to a number of embodiments, the sports tracking device 100 may include a board 102 with a printed surface 104. With particular reference to FIG. 1, the printed surface 104 may include one or more sets 106 of regular-season fields and one or more sets 108 of playoff fields. Each set 106 of the regular-season fields may include a plurality of primary division fields 110 each corresponding to a primary division of the sports league, for example, the American League (AL) West, AL East, National League (NL) West, and NL East. And each set 108 of playoff fields may include a plurality of series fields 112. As shown, in some of the embodiments, the sets 108 of playoff fields may be divided into a plurality of playoff rounds, as indicated by 108a, 108b, and 108c, for Round 1, Round 3, and Round 3, respectively (or AL Division Series, AL Championship Series, and World Series).

A plurality of team icons 114 are respectively associated with the teams of the sports league (e.g., the Los Angeles Dodgers, the San Francisco Giants, the San Diego Padres, and the Arizona Diamondbacks), examples of which icons are shown for clarity in FIG. 2. Each of the team icons 114 is releasably receivable and positionable on the printed surface 104 of the board 102. Accordingly, the icons 114 can be positioned in one of the primary division fields 110 to indicate a current regular-season standing of the teams or in one of the series fields 112 to indicate a current playoff standing of the teams.

More specifically, each of the primary division fields 110 may be divided in a plurality of standing fields 116 for receiving one of the team icons 114 to indicate a current standing of the team in the primary division. For example, the icon 114 marked “LA” in FIG. 1 indicates that the LA team is in first place, with the icon 114 marked “SF” indicates that the SF team is in second place. In addition to standings, the printed surface 104 may also include fields to indicate how many games back a team is from the leader, which is discussed below.

With regard to the playoffs, each of the series fields 112 may be divided into a plurality of games-won fields 118 for receiving one of the team icons to indicate how many games the team has won in a playoff series. For example, the icon 114 marked “B” in FIG. 1 indicates that the B team has won two games of the playoff series, and the icon 114 marked “SL” indicates that that SL team has won one game of the playoff series.

Although any size may be used, in a number of embodiments, the board 102 may be sized approximately equal to a standard piece of paper (e.g., A4, 8½ by 11). Accordingly, rather than needing to utilize a large-sized white board in the past, the board 102 of the invention may be sized to be convenient to carry, distribute, manufacture, print, and so on, while being able to display all the relevant information of a sports league.

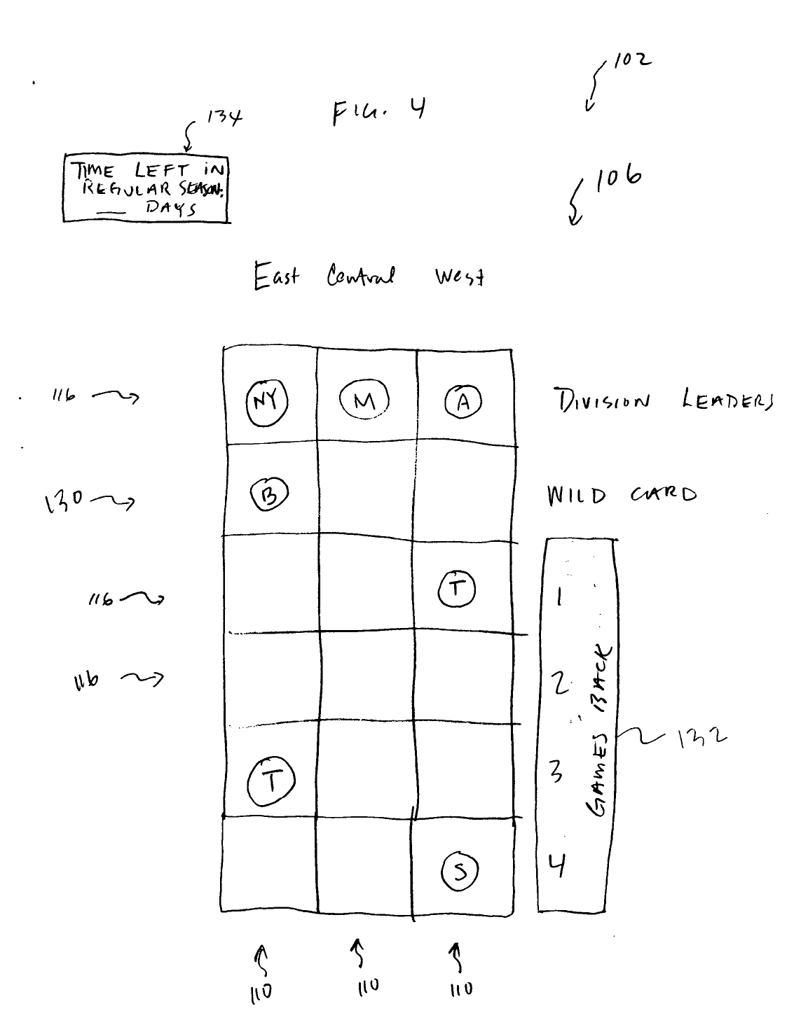

In the embodiments shown in FIG. 3, the board 102 may include a substrate 120, a magnetic layer 122, and a protective surface 124, and each of the team icons 114 may include a magnet 126 and logo element 128. Accordingly, in these embodiments the icons 114 are easily positionable, slidable, and movable across the surface 104 of the board 102. According to the invention, from the start of the season to the finish, nothing needs to be written on the board, nothing needs to be added, and nothing needs to be taken away to represent the relevant information of the league. In other embodiments, the icons 114 may be releasably attached by, for example, hook-and-eye fasteners, pressure-sensitive adhesive, static cling, or pegboard or other mechanical structures.

In a number of embodiments, the icons 114 may be preprinted with team logos on the logo element 128. Alternatively, the logo element 128 may include a tab in which a logo may be inserted. In other embodiments, the logo element 128 may include a user-printable area on which a user may mark desired indicia.

With reference to FIG. 4, each of the primary division fields 110 including a wild-card field 130 for receiving one or more of the team icons 114 to indicate one or more teams that are in a wild-card position. In addition, the set 106 of regular season fields may include a games-back indicator 132 to indicate in relation to the team icons how many games a team is behind a primary division leader. In the example shown, the A team is the division leader of the West division, with the T team in second place one game back and the S team in third place four games back. The NY team is the division leader of the East division, with the B team being the Wild Card for the league, and with the T team being in third place three games back.

In some of the embodiments, the board may also further include a calendar device 134 for indicating a remaining duration of the regular season. For example, the calendar device 134 may indicate how many games are left in the season (as with baseball) or how many weeks are left in the season (as with football). A user may manually change the duration. Alternatively, an electronic counting device may be incorporated into the board 102 to provide this functionality.

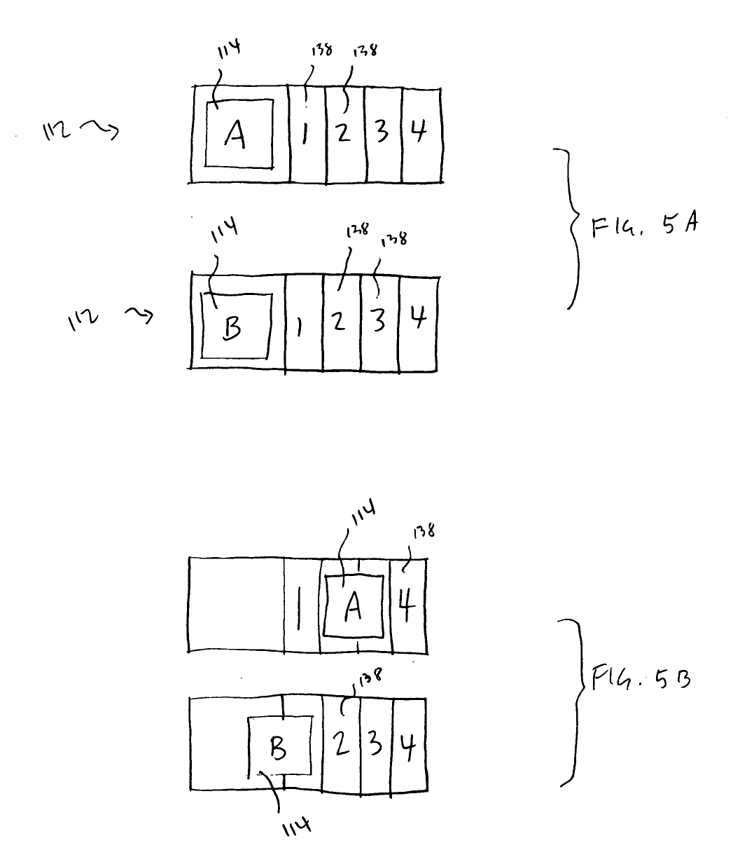

With additional reference to FIG. 5A, in some of the embodiments, each of the games-won fields 112 of the playoff fields 108 may include a numeral indicator 138 over which the team icons 114 are positionable. Accordingly, as shown in FIG. 5B, the team icon 114 can be placed over the numeral indicator 138 to indicate the current wins of the two teams in a particular playoff. In the example shown, the A team leads the B team three games to one.

With reference to FIG. 1, the sets 106 of primary division fields 110 may be divided into secondary division fields as shown, with the secondary division fields representing, for example, the American League and the National League in a baseball example. Accordingly, each of the primary division fields 110 may represent each division (i.e., AL West, Central, and East) of the second division fields.

In a number of embodiments, the set 106 of regular-season fields includes two secondary divisions each including three primary division fields 110; accordingly, such a sports tracking device is configured to display the standings of Major League Baseball® or the National Hockey League®. In other embodiments, the set 106 of regular-season fields includes two secondary divisions each including four primary division fields 110; accordingly, such a sports tracking device is able to display the standings of the National Football League® or the National Basketball Association®. Those skilled in the art will appreciate that the sets of regular-season fields may be divided in any number of ways to accommodate the structure of different leagues.

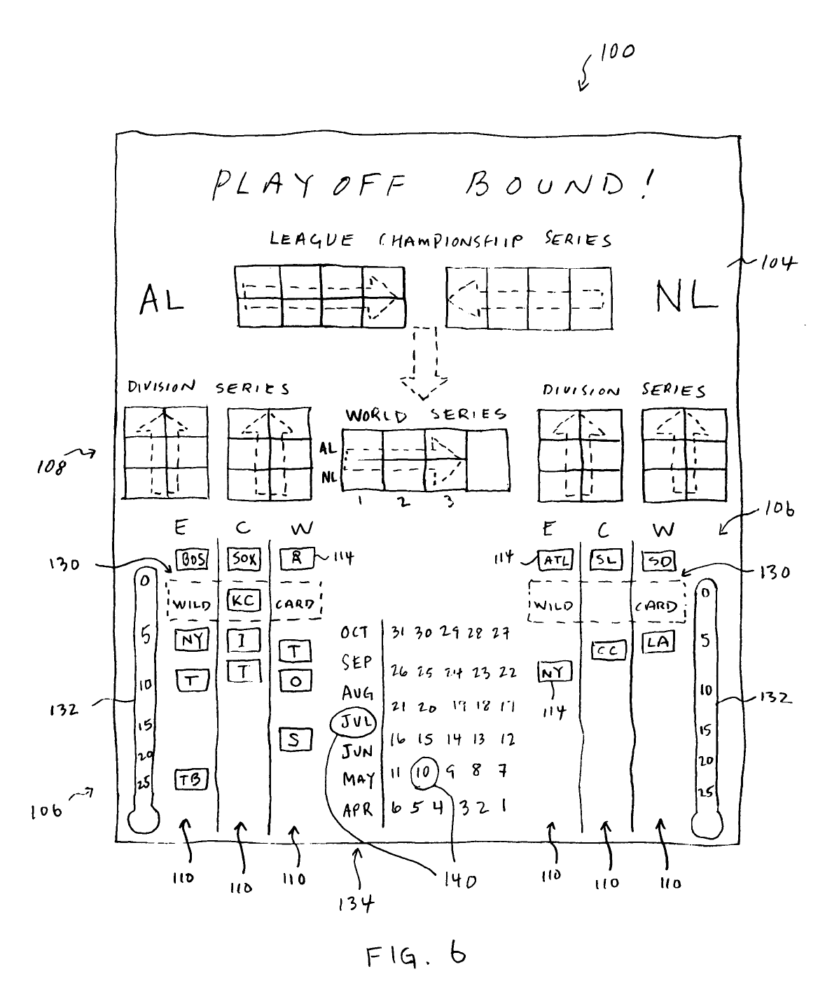

A specific example of Major League Baseball tracking device 100 is shown in FIG. 6. In this example, the current standings of the teams of each league can be maintained within the primary division fields 110. A games-back indicator 132 is provided for both sets 106 of primary division fields. In addition, a calendar device 134 is provided in which date icons 140 may be provided to indicate the current date. As the status of the teams change, the respective icons 114 may be moved to indicate the current status. Accordingly, the board 100 is able to provide a “snap shot” of the status of every team in the league without the use of erasable writing instruments.

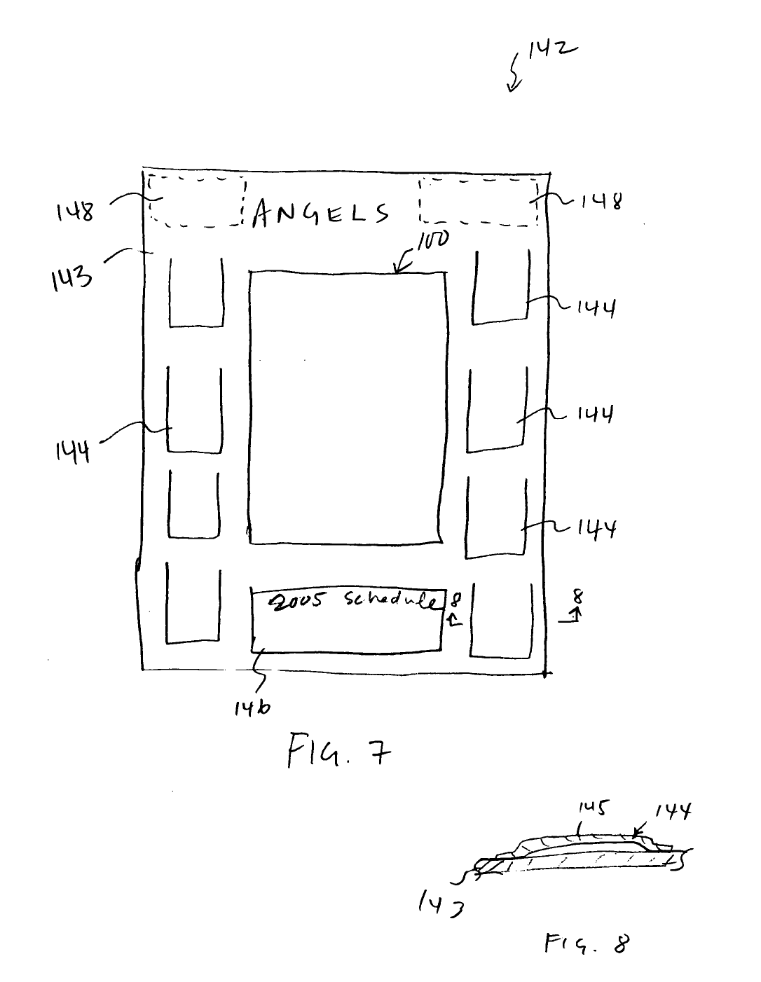

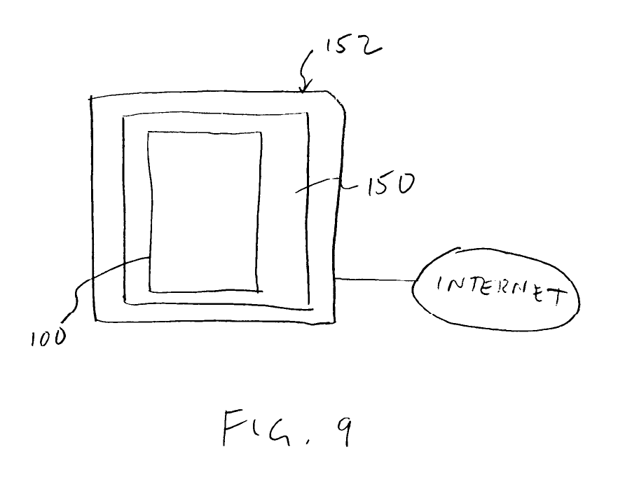

In other embodiments, the sports-tracking device 100 may be incorporated into a team kit 142 as illustrated in FIG. 7. The kit 142 may include a display 143 for receiving the device 100, e.g., the device 100 may be printed on or attached to the display (e.g., by adhesive). The display 143 may also include a plurality of card holders 144 for holding the trading cards of various players on the team. As shown in FIG. 8, the card holders 144 may include a substrate 145 mounted on three sides to the display 143 to form a pocket. In addition, the display 143 may include a team schedule 146. Further, advertising space as indicated at 148 may be provided on the display 143 (as well as on the board 100 itself). The display 143 may be mounted to a wall or otherwise supported for display, such as on a stand.

In still other embodiments, the sports-tracking device 100 may be incorporated in a computer system on a display 150 of a computer 152 connected to the Internet. In these embodiments, the computer 152 can periodically update the current standings or playoff situation of the teams of a sports league.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

1. A sports tracking device for simultaneously displaying a current standing of each team in a sports league, the sports tracking device comprising:
a board having a printed surface, the printed surface including:
a set of regular-season fields including a plurality of primary division fields each corresponding to a primary division of the sports league; and
a set of playoff fields including a plurality of series fields; and
a plurality of team icons respectively associated with a team;
each of the team icons being releasably receivable and positionable on the printed surface of the board;
each of the primary division fields being divided in a plurality of standing fields for receiving one of the team icons to indicate a current standing of the team in the primary division; and
each of the series fields being divided into a plurality of games-won fields for receiving one of the team icons to indicate how many games a team has won in a playoff series.

2. The sports tracking device of claim 1 wherein the board is approximately the size of a standard piece of paper.

3. The sports tracking device of claim 1 wherein the board includes a magnetic layer and each of the team icons includes a magnet.

4. The sports tracking device of claim 1 wherein each of the primary division fields including a wild-card field for receiving one or more of the team icons to indicate one or more teams that are in a wild-card position.

5. The sports tracking device of claim 1 wherein the plurality of series fields are divided into a plurality of round sections.

6. The sports tracking device of claim 1 wherein each of the primary division fields includes a games-back indicator to indicate in relation to the team icons how many games a team is behind a primary division leader.

7. The sports tracking device of claim 1 wherein the printed surface of the board further includes a calendar device for indicating a remaining duration of the regular season.

8. The sports tracking device of claim 1 wherein each of the games-won fields includes a numeral over which the team icons are positionable.

9. The sports tracking device of claim 1 wherein the set of regular-season fields includes two secondary divisions each including three primary division fields;
whereby the sports tracking device is able to display the standings of Major League Baseball® or the National Hockey League®.

10. The sports tracking device of claim 1 wherein the set of regular-season fields includes two secondary divisions each including four primary division fields;
whereby the sports tracking device is able to display the standings of the National Football League® or the National Basketball Association®.

11. A method for simultaneously displaying a current standing of each team in a sports league, the method comprising:
providing a sports tracking device including:
a board having a printed surface, the printed surface including:
a set of regular-season fields including a plurality of primary division fields each corresponding to a primary division of the sports league; and
a set of playoff fields including a plurality of series fields; and
a plurality of team icons respectively associated with a team;
each of the team icons being releasably receivable and positionable on the printed surface of the board;
each of the primary division fields being divided in a plurality of standing fields for receiving one of the team icons to indicate a current standing of the team in the primary division; and
each of the series fields being divided into a plurality of games-won fields for receiving one of the teams icons to indicate how many games the team has won in a playoff series;
positioning the team icons into one of the fields.

12. The method of claim 12 wherein the board includes a magnetic layer and each of the team icons includes a magnet, the method further comprising:
moving one of the team icons by sliding the team icon across the printed surface of the board.

13. A kit for displaying a current standing of each team in a sports league, the kit comprising:
a display;
a sports tracking device disposed on the display and including:
a board having a printed surface, the printed surface including:
a set of regular-season fields including a plurality of primary division fields each corresponding to a primary division of the sports league; and
a set of playoff fields including a plurality of series fields; and
a plurality of team icons respectively associated with a team;
each of the team icons being releasably receivable and positionable on the printed surface of the board;
each of the primary division fields being divided in a plurality of standing fields for receiving one of the team icons to indicate a current standing of the team in the primary division; and
each of the series fields being divided into a plurality of games-won fields for receiving one of the teams icons to indicate how many games the team has won in a playoff series;
a plurality of card holders mounted to the display.

14. The kit of claim 13 wherein the display further includes a team schedule.

15. The kit as claim 13 wherein the display further includes advertising space.
